(19) United States
(12) Patent Application Publication
(10) Pub. No.: US 2004/0020711 A1
(43) Pub. Date: Feb. 5, 2004

(54) Omnidirectional backload horn-type speaker

(76) Inventor: Hiroshi China, Okinawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/630,730

(22) Filed: Jul. 31, 2003

(30) Foreign Application Priority Data
Aug. 1, 2002 (JP) 2002-224393

(51) Int. Cl. G10K 11/00

(52) U.S. Cl. 181/176; 181/191

(57) ABSTRACT

A backload horn-type omnidirectional speaker is provided wherein deterioration of sound due to wound horn portions is prevented such that the listener can enjoy natural sounding music regardless of the position from which the music is listened to.

An omnidirectional backload horn-type speaker 1 is provided comprising: a speaker unit 5 installed facing upwards; a diffuser, made of a cone 9 or the like, located at an upper portion of this speaker unit 5 for reflecting the sound emitted from the speaker unit 5 so that the sound diffuses to the surroundings; and a cylindrical body 2 in substantially conical form or substantially polygonal pyramid form of which the end portion on the upper side is closed and is connected to the rear side of the speaker unit 5 at a lower portion of the speaker unit 5, and of which the end portion on the lower side is provided with a opening 3.

### BACKGROUND OF THE INVENTION

1. Field of the Invention

The present invention relates to an omnidirectional speaker suitable for a variety of locations, such as coffee shops, live band performance shops, museums, art galleries, public squares, or rooms in general households.

2. Description of the Background Art

Conventionally, omnidirectional speakers that gain an approximately uniform sound, regardless of musical genre, in any location within the room in which the speaker is placed, and that do not have a directivity to a specific direction, have been deployed in a variety of locations, such as coffee shops, live band performance shops, museums, art galleries, public squares or rooms in general households.

In general an omnidirectional speaker is directed in the upward or downward direction and a reflector, or the like, in a cone form is provided in front of the speaker and such a speaker structure allows the sound from the speaker to be reflected and dispersed in all directions so that directivity to a specific direction is eliminated.

A woofer having a diameter of 30 cm, or 38 cm, is used for low frequency sound and the rest of the frequency range is divided into several sections, such as a middle frequency sound range and a high frequency sound range, wherein dedicated speaker units are used for the respective sound ranges to reproduce a wide range of the sound according to a conventional speaker system.

In this case parts such as coils, capacitors, and resistors are inserted between the power amplifier and the speaker unit, and numerous distortions in soldering portions as well as in divided networks occur causing aural discrepancies and, concretely, the sound of a violin may sound harsh or the sound of a cymbal may give an echoing sensation to the listener.

On the other hand, though the above described problems do not arise in the case wherein no network is formed so that one speaker reproduces the full frequency range, there is a limitation in regard to the reproduction of low frequency sound by a small speaker and a variety of systems, such as speakers in a bass reflex system, have been created in order to enhance the reproduction of low frequency sound. Horn-type speakers are advantageous for a variety of reasons in that a small sized speaker having a bore diameter of approximately 10 cm to 20 cm or a mid-sized speaker having a bore diameter of approximately 30 cm to 46 cm, can emit low frequency sound up to 20 Hz.

In particular, a backload horn-type speaker having a horn attached to the rear side of the speaker that emits middle and high frequency sound from the front of the speaker and that, at the same time, emits the sound in the low frequency range from the rear of the speaker is advantageous because this type of speaker is similar to a rear side open-type speaker, rather than to a closed-type or a bass reflex-type speaker, wherein the paper of the cone easily moves and, therefore design of a speaker that accurately reproduces a weak signal is made easy.

The horn portion occupies the largest space in the case of the above described backload horn-type speaker, and therefore, the inside of a cabinet 31 in a rectangular form is partitioned in a complicated manner as shown in the side cross sectional view of FIG. 4, so that a portion of a horn 32 is formed in a wound state in most of the conventional speakers.

In the case of the speaker having a cabinet such as the cabinet 31 in a rectangular form, however, the sound reflects from a winding portion 34 of the horn at the time when the sound emitted from the rear side of a speaker unit 33 passes through the horn 32, and therefore there is a risk wherein too many winding portions 34 may lead to a reduction in the purity of the sound.

Therefore a purpose of the present invention is to provide an omnidirectional speaker, even in the case of the backload horn-type omnidirectional speaker, that can solve the above described problems and prevent deterioration of the sound caused by the folds of the winding portion, so that the listener can enjoy natural music from whichever position he or she listens.

### SUMMARY OF THE INVENTION

In order to solve the above described problems the invention according to claim 1 provides an omnidirectional backload horn-type speaker characterized by comprising: a speaker unit installed facing upwards; a diffuser located at an upper portion of the speaker unit for reflecting the sound emitted from the speaker unit so that the sound diffuses to the surroundings; and a cylindrical body in substantially conical form or substantially polygonal pyramid form, of which the end portion on the upper side is closed and is connected to the rear side of the speaker unit at a lower portion of the speaker unit, and of which the end portion on the lower side is open.

A speaker providing a full range of the sound frequencies is preferable as the speaker unit of the above described invention according to claim 1 and a double cone-type speaker unit in addition to a single cone-type speaker unit may be used and furthermore a triple cone type speaker unit having three cones, as described in the below invention according to claim 3, may be used.

It is preferable for the diffuser located at an upper portion of the speaker unit to be installed in a manner wherein a speaker cone in a conical form is placed facing downward, and the form thereof is not limited to an exact conical form but rather may be a shape similar to a conical form such as a polygonal pyramid or hemispherical form. In summary, any form and material may be used for the diffuser as long as the diffuser uniformly reflects the sound emitted from the speaker in all directions to the surrounding area by placing the diffuser so as to face the speaker unit such that the center axis of the speaker unit and of the diffuser are in alignment with each other.

A variety of forms, such as a cone, a quadrangular pyramid and a hexagonal cone, which spreads in the downward direction,can be adopted for the form of the cylindrical body in substantially conical or substantially polygonal pyramid form of which the end portion on the upper side is closed and is connected to the rear side of the speaker unit, and of which the end portion on the lower side is open.

It is necessary for the dimensions of the cylindrical body to have a greater area for the path of the sound at a position closer to the exit side so that the manner of increase of the area is close to that of an exponential curve according to the design of the horn of the speaker, and the area of the path of the sound expands along the axis of the horn form moving outward from the speaker when the horn has a conical or polygonal prism form.

The low frequency sound emitted from the lower portion on the rear side of the speaker unit reaches to a lower portion of the cylindrical body by following a straight course through the cylindrical body, as opposed to a winding course, without being reflected on the way, and then diffuse to the surrounding area from the lower portion of the cylindrical body in the above described configuration. In addition, middle and high sound frequencies emitted from the upper portion of the cylindrical body to the front of the speaker unit are defused to the surrounding area by means of the diffuser and therefore an omnidirectional speaker can be gained using a backload horn-type speaker unit providing a full range of sound frequencies that allow the listener to hear natural music without distortion uniformly from any position.

In addition the invention according to claim 2 provides an omnidirectional backload horn-type speaker characterized by comprising: a speaker unit installed in a lateral direction; a diffuser located in front of the speaker unit for reflecting the sound emitted from the speaker unit so as to diffuse the sound across 180° in front of the speaker; and a cylindrical body in substantially conical form or substantially polygonal pyramid form of which the end portion on the upper side is closed and is connected to the rear side of the speaker unit at a lower portion of the speaker unit, and of which the end portion on the lower side is open.

The speaker unit of the present invention according to claim 2 differs from that of claim 1 in the point that the speaker unit of claim 2 is placed in a lateral direction while the speaker unit and the cylindrical body of the speaker unit according to claim 2 are the same as of claim 1.

It is necessary for the diffuser positioned in front of the speaker unit to diffuse the sound over a range of 180° in the frontal horizontal direction while allowing the sound to pass outward through the diffuser from the front of the speaker unit.

As an example of such a diffuser, diffusing plates made of two flat plates are placed so as to form an angle of for example 90° in the horizontal direction wherein a slit remains extending in the upward and downward directions between the two diffusing plates. This slit is positioned directly in front of the speaker unit and the right and left diffusing plates are placed in a symmetrical manner vis-à-vis the speaker unit.

In this case the sound that have been emitted from the speaker unit and have struck the left diffusing plate are reflected so that the sound diffuses over a range of 45° on the left side while the sound that have struck the right diffusing plate are reflected so that the sound diffuses over a range of 45° on the right side.

Furthermore the sound that have passed through the slit between the diffusing plates diffuse over the frontal range of 90° between the two diffusing plates and therefore the sound spreads over a frontal range of 180° together with the sound that diffuses to the left and to the right. Thus the sound diffuses throughout the entirety of a room in the case wherein the speaker unit is installed on a wall or the like of the room so as to face inside of the room.

In addition the invention according to claim 3 provides the omnidirectional backload horn-type speaker according to claim 1 or 2, characterized in that the speaker unit has a first cone provided on the outside, a second cone provided inside of the first cone, and a third cone in a tapered conical form provided inside of the second cone.

A speaker cone configured in a tapered conical form is added as a third cone to the configuration of a conventional double cone-type speaker unit according to the present invention of claim 3, and high frequency (high frequency sound) waves having a high density and a high energy are released to the front of this speaker unit by means of this configuration.

Though the principle according to which the above phenomenon is produced is not fully understood, it is presumed that the high frequency sound cannot escape in the lateral direction in a valley (portion in a ring form having a V-shaped cross section) placed between the two cones, wherein the second cone is in a spreading form and the third cone is in a tapered form inside of the second cone, and is released to the front (above the V-shape of the cross section) so as to become high frequency sound having a high density and a high energy.

Though this high frequency sound emitted from the front of the speaker unit has a strong directivity outward from the speaker unit, the sound is reflected by the. diffuser placed directly in front of the speaker unit so as to diffuse in all directions and therefore rich, high frequency sound diffuses in all directions without directivity in the case wherein the speaker unit of the omnidirectional speaker according to claim 1 or 2 is used.

All of the wires inside of the speaker are connected by means of welding and, therefore, it becomes possible for one speaker to produce sounds of all frequency bands, that is, low frequency sound, middle frequency sound and high frequency sound, unlike a speaker having conventional connections by means of soldering. In addition, a heating element is provided within the speaker enclosure, specifically, on the rear side of the magnet and, therefore, mellow and extended sound is outputted by the speaker immediately after the switch of the audio unit has been turned on without warming up the speaker.

### BRIEF DESCRIPTION OF THE DRAWINGS

FIG. 1(A) is a frontal cross sectional view showing an example of an omnidirectional backload horn-type speaker and FIG. 1(B) is an enlarged perspective view of the main portion of the speaker in FIG. 1(A);

FIG. 2(A) is a plan cross sectional view showing another example of an omnidirectional backload horn-type speaker, FIG. 2(B) is an enlarged side view of the main portion of the speaker in FIG. 2(A) and FIG. 2(C) is an enlarged perspective view of the main portion of the speaker in FIG. 2(A);

FIG. 3(A) is a frontal view showing an example of a speaker unit used for the present invention, FIG. 3(D) is a partial cross sectional side view of the speaker unit of FIG. 3(A) and FIG. 3(C) is a perspective view of the speaker unit of FIG. 3(A); and

FIG. 4 is a cross sectional side view of a backload horn-type speaker according to a prior art.

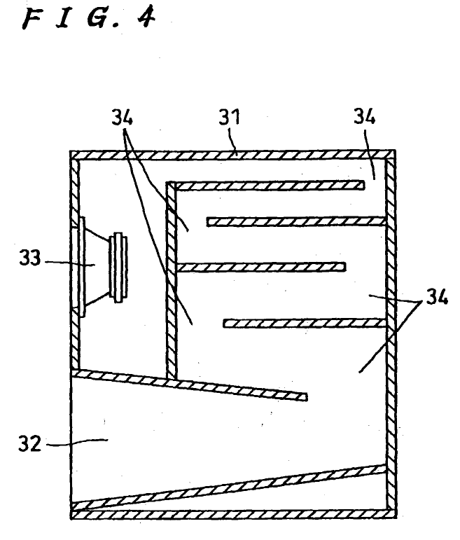

### DESCRIPTION OF THE PREFERRED EMBODIMENTS

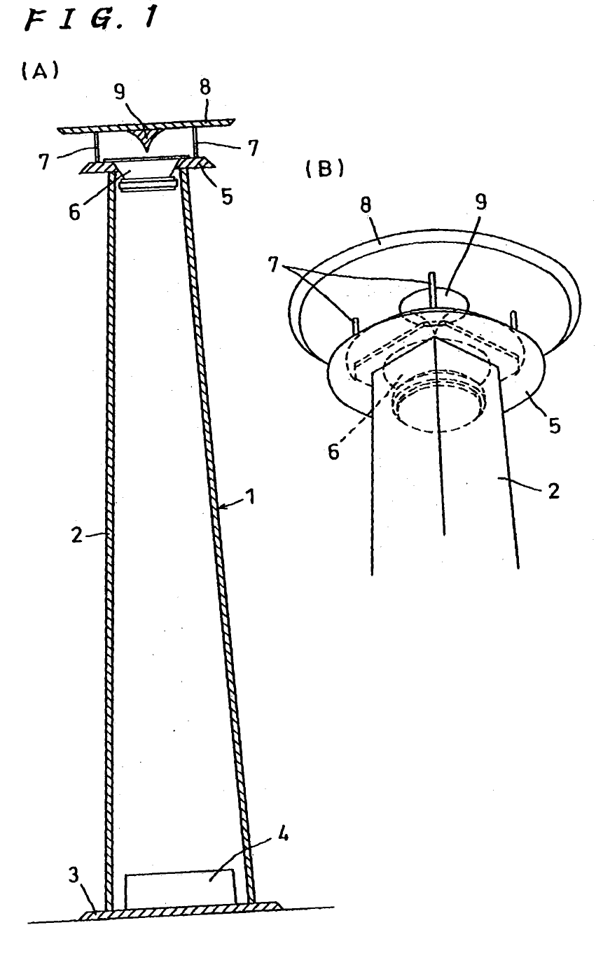

In the following the embodiments of the present invention are described in reference to FIGS. 1 to 3.

FIG. 1(A) is a frontal cross sectional view showing one example of a speaker according to claim 1 of the present invention and FIG. 1(B) is an enlarged perspective view of the main portion of the speaker in FIG. 1(A).

The height of this omnidirectional speaker 1 is approximately 2 m and has dimensions such that it can easily be installed in a standard public hall or a store.

A cylindrical body 2 is made of a lightweight and rigid material such as wood, and has a hollow pyramidal form that spreads in the downward direction, having the dimensions wherein the length of one side of the base is from approximately 40 cm to 50 cm and the length of one side of the top is from approximately 15 cm to 20 cm, and a notch is provided in a lower portion of each of the sides so that openings 4 are provided between the base of the speaker and a support base 3.

The upper end of the cylindrical body 2 is covered with a disc shaped support plate 5 of a diameter of approximately 30 cm and of which the periphery is in a tapered form that spreads in a downward direction having an area greater than that of the top of the cylindrical body 2 and a circular hole is provided in the center of this support plate 5 so that a speaker unit 6 of a diameter of from approximately 10 cm to 20 cm, which allows for a full range of sound frequencies from approximately 20 Hz to 20000 Hz and faces in the upward direction, fits into, and is supported within this hole.

A top plate 8 in a disc form of a diameter of approximately 40 cm, which is slightly greater than the support plate 5, is placed on top of and is supported by a support post 7 which extend vertically upwardly from the four points on the top surface of the support plate 5, and the periphery of this top plate 8 has been shaped in a tapered form that spreads in an upward direction, which is opposite to that of support plate 5, and a cone 9 in approximately a conical form facing in a downward direction, and facing the speaker unit 6, is fixed in the center of the top plate 8.

This cone 9 serves as a diffuser of the sound and is made of a hard material from which the sound is reflected. This cone 9 has a diameter approximately the same as that of the speaker unit 6 and the angle of the cone thereof is 45° so that the direction of the sound that have been emitted from the speaker unit 6 in an upward direction is changed to a lateral direction after the sound is reflected by the inclined surface of the cone 9, wherein the cone 9 is in approximately a conical form, so that the sound is reflected uniformly in all directions over the surrounding area and the reflected sound is emitted between the top plate 8 and the support plate 5 so as to diffuse in a horizontal direction over 360° of the surrounding area.

Here though the inclined surface of the cone 9 in FIG. 1 is curved, it may also be shaped in a precise conical form. Alternatively it may be:a polygonal pyramid, in an approximately conical form having a curved surface, or in a hemispherical form because it is not, as described above, necessarily limited to a conical form as long as the cone 9 has a form and a material that allows for the sound emitted from the speaker unit 6 to be uniformly reflected in all directions of the surrounding area by placing the cone 9 so that the center axis of the speaker unit. 6, and the center axis of the cone 9, are in alignment with each other.

The omnidirectional backload horn-type speaker 1 of the present invention having the above described configuration or installed in an arbitrary position indoors or outdoors so that middle and high frequency sound emitted from the speaker unit 6 placed facing in an upward direction is diffused in all horizontal directions over 360° by the diffuser made of the cone 9 or the like, and the sound reaches all positions in the room and not only specific listening positions. Furthermore, a rich low frequency sound can be attained from the openings 4 in the lower portion of the cylindrical body 2 of the backload horn-type speaker in a natural state without distortion due to unnatural reflection from a winding portion of a horn that exists in a conventional backload horn-type speaker.

Here, the backload horn-type omnidirectional speaker 1 of the present invention is not limited to the above described embodiment of FIG. 1, but rather the material, form, and dimensions of the cylindrical body 2, or the designs of utilized the speaker unit 6 or of the diffuser made of the cone 9 can be appropriately modified according to the place and purpose of utilization.

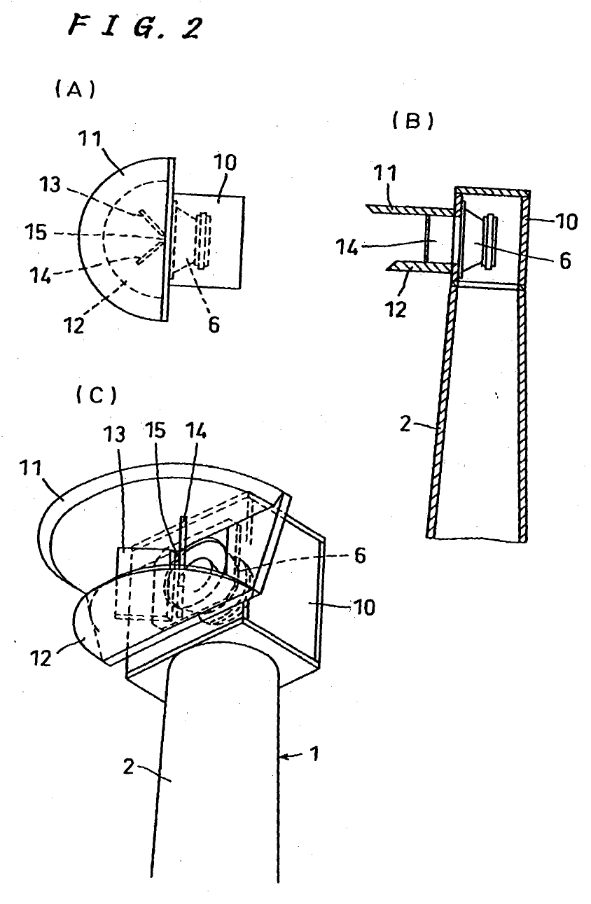

FIG. 2(A) is a plan cross sectional view of an example of a speaker according to claim 2 of the present invention, FIG. 2(B) is an enlarged side view of the main portion of the speaker, and FIG. 2(C) is an enlarged perspective of the main portion of the speaker.

The height of this omnidirectional speaker 1 is approximately 2 m which is the same as the height of the speaker in FIGS. 1(A) and 1(B), and the speaker has dimensions such that it can easily be installed in standard public halls or stores.

A cylindrical body 2 is made of lightweight and rigid material such as wood and has a hollow conical form that spreads in a downward direction according to this embodiment. Here the lower portion of the cylindrical body is similar to that of FIG. 1 and has a support base 3 and openings 4.

A box 10 in a rectangular form of which the inside is connected to the cylindrical body 2 is provided on top of the cylindrical body 2, and a speaker unit 6 of a diameter of from approximately 10 cm to 20 cm for emitting a full range of sound frequencies of from approximately 20 Hz to 20000 Hz, which is similar to that of FIG. 1, is fixed to one of the sides of this box 10 in a state facing in a lateral direction.

An upper support plate 11 and a lower support plate 12 each in a semicircular form are provided to the top and to the bottom of the speaker unit 6 on the side of the box 10 where the speaker unit 6 is located, and the upper support plate 11 has a diameter of approximately 40 cm and has a periphery tapered in a downward direction while the lower support plate 12 has a diameter of approximately 30 cm and has a periphery tapered in an upward direction.

Two diffusing plates 13 and 14, each in a rectangular form, are supported by the upper support plate 11 and the lower support plate 12, forming an angle of 90° in a lateral direction between these two support plates.

The gap between the diffusing plates 13 and 14 is a vertical slit 15 and this slit 15 is positioned directly in front of the center of the speaker unit 6.

These diffusing plates 13 and 14 are made of a hard material that reflects the sound so as to serve as a diffuser of the sound and diffuse the sound emitted from the speaker unit 6 to the surrounding area.

The sound that has been emitted from the speaker unit 6 and have struck left diffusing plate 13, as viewed facing the speaker unit 6, are reflected and the sound is diffused in a range of 45° on the left side of the speaker unit while the sound that has been emitted from the speaker unit 6 and have struck right diffusing plate 14 are reflected and the sound is diffused in a range of 45° on the right side of the speaker unit and furthermore the sound that has passed through the slit 15 between the diffusing plates 13 and 14 are diffused in a frontal range of 90° between the two diffusing plates 13 and 14, and the sound spreads, together with the sound diffused to the right and left of the speaker unit, in a frontal range of 180° starting from an area between the upper support plate 11 and the lower support plate 12.

This omnidirectional backload horn-type speaker of FIG. 2 is installed on a portion of a wall within a room so that the speaker unit 6 faces the inside of the room and thereby the middle and high frequency sound that has been diffused by the diffuser made of the diffusing plates 13 and 14 spreads over the entire range of 180° within the room without being limited to a specific listening position. Furthermore, a rich low frequency sound can be attained from the lower portion of the cylindrical body 2 of the backload horn-type speaker in a natural state without distortion due to unnatural reflection from a winding portion of a horn that exists in a conventional backload horn-type speaker.

Here, the omnidirectional backload horn-type speaker 1 shown in FIG. 2 is also not limited to the above described embodiment of FIG. 1, but rather the material, form, and dimensions of the cylindrical body 2, or the designs of utilized speaker unit 6 can be appropriately modified according to the place and purpose of utilization and in addition the angle formed between the diffusing plates 13 and 14 do not necessarily have to be 90° as shown in the figure but rather can be set in a range of from approximately 60° to 120°, for example.

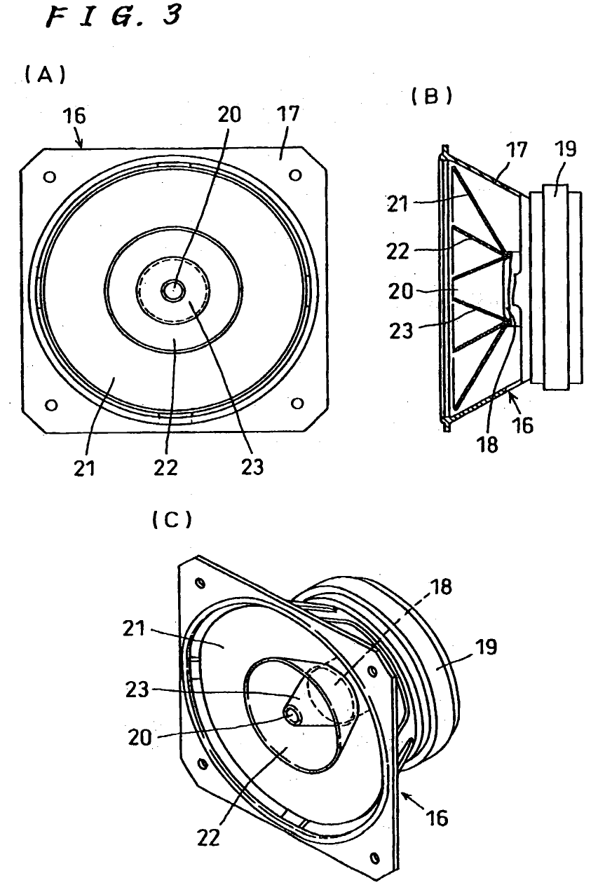

FIG. 3(A) is a frontal view of a speaker unit 16 according to claim 3 of the invention used in an omnidirectional backload horn-type speaker of the present invention, FIG. 3(B) is a partial cross sectional side view of the speaker unit and FIG. 3(C) is a perspective of the speaker unit.

The configuration of this speaker unit 16 is made up of a frame 17, a voice coil 18, a magnet 19 and the like, and in addition has a first cone 21 of which the inside interlocks with the voice coil 18 and of which the periphery is connected to the frame 17 in the same manner as with a conventional double cone-type speaker as well as a second cone 22 of which the inside interlocks with the voice coil, and of which the portion within the first cone is provided in a form that spreads outward in the same manner as the first cone.

Furthermore, a third cone 23 in a truncated top conical form, which is tapered and which has an opening 20 on top, is provided inside of the second cone 22.

The high frequency sound cannot escape in the lateral direction relative to the access direction of the speaker unit 16 in a valley (portion in a ring form having a V-shaped cross section) placed between the second cone 22 and the third cone 23, and is released only to the front (above the V-shape of the cross section) and thereby the high frequency sound develops a high density and a high energy.

Here, though the opening 20 on top of the third cone 23 has a function of allowing air to escape for smooth movement of the cone, it is not essential, and the third cone 23 may be in a precise conical form which is tapered without having the opening 20 on top.

Though high frequency components (high frequency sound) primarily are released from a portion in a donut-shape between the second cone and the third cone of this speaker unit, and the released sound has a strong frontal directivity, high frequency sound having a high density and a high energy and having no specific directivity can be received at all listening positions because the sound is diffused by the cone 9 and by the diffusing plates 13 and 14, which serve as a diffuser, in the case wherein this speaker unit 16 is used as the speaker unit 6 of the speaker 1 shown in FIG. 1 or FIG. 2 having the configuration of the present invention.

All of the wires inside of the speaker are connected by means of welding and, therefore, it becomes possible for one speaker to produce sounds of all frequency bands, that is, low frequency sound, middle frequency sound and high frequency sound, unlike a speaker having conventional connections by means of soldering. In addition, a heating element is provided within the speaker enclosure, specifically, on the rear side of the magnet and, therefore, mellow and extended sound is outputted by the speaker immediately after the switch of the audio unit has been turned on without warming up the speaker.

As described above, a listener can enjoy rich low frequency and natural sound produced by a backload horn-type speaker as well as clear low frequency sound which has not undergone unnecessary reflections from wound horn portions of a conventional backload horn-type speaker without the need for selecting a specific listening position in accordance with an omnidirectional speaker according to claim 1 or 2 of the invention.

In addition, high frequency sound components having very strong directivity are uniformly diffused from a high location in the vicinity of the top of the speaker so as to spread throughout the room and therefore there is an advantage wherein the listener is not disturbed by the sound even if he or she is seated very close to this speaker due to the specific seating arrangement within a small public space.

Furthermore, the speaker is formed in a pillar shape so as to be installable in any location and the speaker can be utilized for varied applications such that the speaker can be installed without affecting the appearance of the surroundings, or on the contrary, it is possible to decorate the speaker in order to emphasize its presence.

In addition, high frequency sound components having a high density and a high energy can be produced by using the speaker unit according to claim 3 of the invention, which is combined with the clear low frequency sound that has been produced by the backload horn and that has not been reflected, so that music pleasing to the ear can be enjoyed from any position.

All of the wires inside of the speaker are connected by means of welding and, therefore, it becomes possible for one speaker to produce sounds of all frequency bands, that is, low frequency sound, middle frequency sound and high frequency sound, unlike a speaker having conventional connections by means of soldering. In addition, a heating element is provided within the speaker enclosure, specifically, on the rear side of the magnet and, therefore, mellow and extended sound is outputted by the speaker immediately after the switch of the audio unit has been turned on without warming up the speaker.

What is claimed is:

1. An omnidirectional backload horn-type speaker characterized by comprising: a speaker unit installed facing upwards; a diffuser located at an upper portion of the speaker unit for reflecting the sound emitted from the speaker unit so that the sound diffuses to the surroundings; and a cylindrical body in substantially conical form or substantially polygonal pyramid form of which the end portion on the upper side is closed and is connected to the rear side of the speaker unit at a lower portion of the speaker unit, and of which the end portion on the lower side is open.

2. An omnidirectional backload horn-type speaker characterized by comprising: a speaker unit installed in a lateral direction; a diffuser located in front of the speaker unit for reflecting the sound emitted from the speaker unit so as to diffuse the sound across 180° in front of the speaker; and a cylindrical body in substantially conical form or substantially polygonal pyramid form of which the end portion on the upper side is closed and is connected to the rear side of the speaker unit at a lower portion of the speaker unit, and of which the end portion on the lower side is open.

3. The omnidirectional backload horn-type speaker according to claim 1 or 2, characterized in that the speaker unit has a first cone provided on the outside, a second cone provided inside of the first cone, and a third cone in a tapered conical form provided inside of the second cone.

4. The omnidirectional backload,horn-type speaker according to any of claims 1, 2 and 3, characterized in that all of the wires inside of the speaker are connected by means of welding.

5. The omnidirectional backload horn-type speaker according to any of claims 1, 2, 3 and 4, characterized in that a heating element is provided within the speaker enclosure.
